(19) United States
(12) Patent Application Publication
(10) Pub. No.: US 2014/0181751 A1
(43) Pub. Date: Jun. 26, 2014

(54) DEVICE AND METHOD FOR PROVIDING RELEVANT APPLICATIONS

(71) Applicant: Pantech Co., Ltd., Seoul (KR)

(72) Inventors: Kyung-Sun WON, Seoul (KR); Young-Su JANG, Seoul (KR); Yun-Suk CHOI, Seoul (KR)

(73) Assignee: Pantech Co., Ltd., Seoul (KR)

(21) Appl. No.: 14/105,815

(22) Filed: Dec. 13, 2013

(30) Foreign Application Priority Data
Dec. 21, 2012 (KR) 10-2012-0150700

(51) Int. Cl. G06F 3/0481; G06F 3/0484

(52) U.S. Cl. CPC G06F 3/04817; G06F 3/04842
USPC 715/835

(57) ABSTRACT

A method for identifying a relevant application includes displaying a plurality of icons corresponding to applications, selecting an icon corresponding to a target application from among the plurality of displayed icons, determining a category of the target application, and identifying a relevant application based on the determined category of the target application. A device to identify a relevant application includes a display unit to display a plurality of icons corresponding to applications, an input unit to receive a selection of an icon corresponding to a target application from among the plurality of icons, and a control unit to determine a category of the target application, and to identify a relevant application based on the determined category of the target application.

### CROSS-REFERENCE TO RELATED APPLICATION

This application claims priority from and the benefit under 35 U.S.C. §119(a) of Korean Patent Application No. 10-2012-0150700, filed on Dec. 21, 2012, the entire disclosure of is incorporated herein by reference for all purposes.

### BACKGROUND

1. Field

The following description relates to a device and method for providing a relevant application to a terminal device.

2. Discussion of the Background

The use of high-end mobile terminals, such as smartphones, is increasing. Such a high-end mobile terminal is equipped with a high-performance processor and large-capacity memory, thereby allowing a user to install a variety of applications.

A smartphone, as an intelligent mobile terminal, incorporates general functions of a mobile phone along with other computing functions, such as a schedule organizer function, and a data communication function (e.g., Internet access). These smartphone have been rapidly gaining recognition as a leading device in the mobile phone market due to advantageous characteristics, such as capability of directly accessing the Internet through wireless communications, capability of installing a variety of applications, and capability of easily sharing various data with other smartphones with the same operating system (OS). Along with the popularization of the smartphone, there is a rising need for a variety of applications, resulting in the development of more applications for the smartphones.

Generally, when the user wants to run a specific application among different applications installed in the smartphone, the user searches for the application manually. This method may be inconvenient to the user if there are many applications installed in the smartphone.

### SUMMARY

Exemplary embodiments of the present invention provide a device and method for providing a relevant application.

Additional features of the invention will be set forth in the description which follows, and in part will be apparent from the description, or may be learned by practice of the invention.

Exemplary embodiments of the present invention provide a method for identifying a relevant application corresponding to a target application, the method including is displaying a plurality of icons corresponding to applications; selecting an icon corresponding to a target application from among the plurality of displayed icons; determining a category of the target application; and identifying a relevant application based on the determined category of the target application.

Exemplary embodiments of the present invention provide a device to identify a relevant application corresponding to a target application, the device including a display unit to display a plurality of icons corresponding to applications; an input unit to receive a selection of an icon corresponding to a target application from among the plurality of icons; and a control unit to determine a category of the target application, and to identify a relevant application based on the determined category of the target application.

Exemplary embodiments of the present invention provide a method for identifying a relevant application corresponding to a target application, the method including displaying a plurality of icons corresponding to applications; selecting an icon corresponding to a target application from among the plurality of displayed icons; extracting application properties information corresponding to the applications from a database; categorizing applications based on the extracted application properties information; determining order of relevance for the categorized applications; and providing a relevant application based on at least one of a categorization and relevance of the target application.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the principles of the invention.

FIG. 1 illustrates a configuration of a device to provide a relevant application according to an exemplary embodiment of the present invention.

FIG. 2 illustrates a configuration of a database unit to store categories of an application according an exemplary embodiment of the present invention.

FIG. 3A, FIG. 3B, FIG. 3C and FIG. 3D illustrate a user input method for requesting relevant applications according to exemplary embodiments of the present invention.

FIG. 4A and FIG. 4B illustrate diagrams of a display screen displaying icons associated with applications relevant to a certain application according to an exemplary embodiment of the present invention.

FIG. 5A and FIG. 5B illustrate diagrams of a display screen displaying applications relevant to a certain application on a category basis according to an exemplary embodiment of the present invention.

FIG. 6 illustrates a flowchart of a method for providing relevant applications according to an exemplary embodiment of the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. It will be understood that for the purposes of this disclosure, “at least one of X, Y, and Z” can be construed as X only, Y only, Z only, or any combination of two or more items X, Y, and Z (e.g., XYZ, XZ, XYY, YZ, ZZ). Throughout the drawings and the detailed description, unless otherwise described, the same drawing reference numerals are understood to refer to the same elements, features, and structures. The relative size and depiction of these elements may be exaggerated for clarity.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. Although some features may be described with respect to individual exemplary embodiments, aspects need not be limited thereto such that features from one or more exemplary embodiments may be combinable with other features from one or more exemplary embodiments.

An application described in the following description may include one or more applications to execute one or more operations offered by a device, such as a mobile terminal, and/or applications downloaded from an external source. For example, the application may include, without limitation, an image viewer application, a camera application, a video player application, a document viewer application, an email application, a memo or note application, a short message service (SMS) or multimedia messaging system (MMS) messaging application, a schedule management application, and an instant messenger service application, a variety of game applications, and the like. The device, such as a mobile terminal, may include hardware components, such as one or more processors, a memory, a touch screen display, a camera, and the like. Also, the units, modules, elements, applications, and components of the apparatuses, systems, and/or terminals herein described, may include hardware and software, may also include firmware, to perform various operations of the terminal including those described herein, may be combined or remain separate, and may be stored in one or more storage devices or computer-readable media. According aspects of the invention, a device may be a mobile terminal, a cellular telephone, a smartphone, a tablet computer, a laptop computer, a desktop computer, and the like.

A term of category may indicate or refer to a type of applications, which may be classified according to a predetermined criterion or a user selection. A term of touch may indicate or refer to a state in which a user's hand or a stylus pen may be in contact with a touch screen. A term of drag may indicate or refer to moving of an icon on a touch screen while maintaining a touch on the icon with a user's finger or a stylus pen. Term of drag and drop may indicate or refer to the action of moving an icon to a desired position on a touch screen while maintaining a touch on the icon with a user's finger or a stylus pen and then removing the finger or the stylus pen from the touch screen.

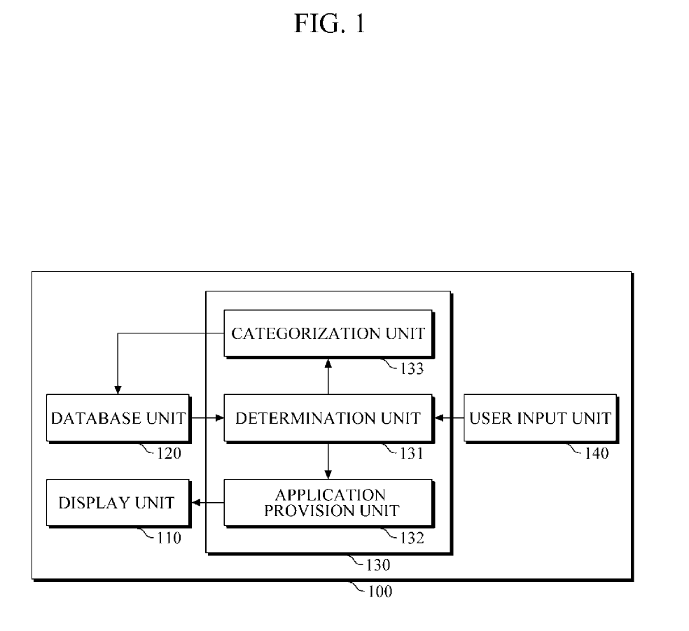

FIG. 1 illustrates a configuration of a device to provide a relevant application according to an exemplary embodiment of the present invention.

Referring to FIG. 1, device 100 to provide a relevant application includes a display unit 110, a database unit 120, a control unit 130, and a user input unit 140.

The display unit 110 may display a representative image or symbol corresponding to one or more applications. The display unit 110 may also display user interface and data related to the respective applications. For example, the display unit 110 may display one or more icons associated with applications. In addition, the display unit 110 may display a home screen and/or a menu screen. The home screen and/or the menu screen may display at least one executable application icon. Generally, on the menu screen, icons corresponding to some or all applications installed in the device 100 may be displayed, whereas on the home screen only the icons of applications chosen by the user are may be displayed. The user may switch between the home screen and the menu screen by clicking a specific button or key on the device 100. Further, if the display unit 110 includes a touch screen or a touch panel, the user may switch between the screens by touching a specific portion of the display unit 110.

The database unit 120 may store application properties information. For example, the application properties information may include, without limitation, at least one of category information, name information, whether the application belongs to a folder created by the user, application execution history information, package name information, and use information of hardware parts included in the device 100. The hardware parts of the device may include, without limitation, at least one of a Bluetooth® device, a camera, a global positioning system (GPS) device, a near field communication (NFC) device, a digital multimedia player (DMB) device, and the like. A method for storing the category information in the database unit 120 will be described in more detail below.

The control unit 130 may control one or more operations of the device 100.

The control unit 130 may determine and/or provide one or more applications relevant or related to an application selected by the user. Referring again to FIG. 1, the control unit 130 includes a determination unit 131, an application provision unit 132, and a categorization unit 133.

The determination unit 131 may evaluate or determine the relevance of applications stored or installed in the device 100 with respect to one another based on corresponding application properties information present in the database unit 120. For example, the determination unit 131 may evaluate or determine the relevance of one or more applications stored and/or installed in the device 100 with respect to a target application, which may correspond to an icon selected by a user.

For example, the determination unit 131 may evaluate the relevance of the applications with reference to categories of an application, which may be used to search for applications in a server, such as a third party application market or store, to provide applications. For example, the determination unit 131 may determine that the applications belonging to the same category are relevant to each other. In addition, the determination unit 131 may evaluate the relevance of applications based on a name of an application. More specifically, the determination unit 131 may determine that the applications with the same or similar names or the application having the same first letter or word in their names are relevant to each other. Further, the determination unit 131 may evaluate the relevance of the applications based on storage location of icons or symbols corresponding to the applications. For example, the determination unit 131 may determine that when the applications or their icons are included in the same folder, the corresponding applications are relevant to each other. Moreover, the determination unit 131 may evaluate the relevance of the applications based on application execution history. For example, the determination unit 131 may determine that applications frequently running at a particular time period are relevant to each other based on execution history or other record corresponding to the applications. Further, the determination unit 131 may determine that applications frequently running at a particular location are relevant to each other based on execution history or other records corresponding to the applications. Moreover, the determination unit 131 may determine, based on an order of running applications, that applications which are frequently run within a particular time interval are relevant to each other. Further, the determination unit 131 may evaluate the relevance of applications based on a package name of one or more applications. Because one or more applications may have a unique package name, the determination unit 131 may determine that applications with the same or similar package names are relevant to each other. Further, the determination unit 131 may evaluate the relevance of the applications based on use information of hardware parts included in the device. The determination unit 131 may determine that the applications using the same or related hardware parts of the device are relevant to each other.

However, aspects of the invention are not limited thereto, such that the determination unit 131 may evaluate the relevance of applications with respect to a target application using various methods.

The application provision unit 132 may provide applications relevant to the target application selected by the user through the user input unit 140, based on the relevance of the applications determined by the determination unit 131.

For example, when the relevance of one or more applications are determined by the determination unit 131 based on the category information present in the database unit 120, the application provision unit 132 may provide the relevant applications according to application extraction characteristics of categories present in the database 120. The application extraction characteristics or a category type may be determined based on a method for identifying an application corresponding to a category. There may be at least two types of application extraction characteristics or categories.

With respect to a target application belonging to a first type of category, relevant applications may be identified or extracted based on the order of corresponding categories stored in the database. For example, an application may belong to four categories in particular order, such as category 1, category 4, category 3, and category 2, respectively. According to aspects of the invention, the order of categories may be based on order of relevance. If a relevant application having category 1 as the first category is to be extracted as a relevant application, applications having category 1 designated as the first category may be extracted or identified as a relevant application to the target application having a category or an application extraction characteristic of a first type. However, aspects of the invention are not limited thereto, such that second category may be considered, or a combination of categories in various orders may be considered in extracting or identifying a relevant application for a target application having a category or an application extraction characteristic of a first type.

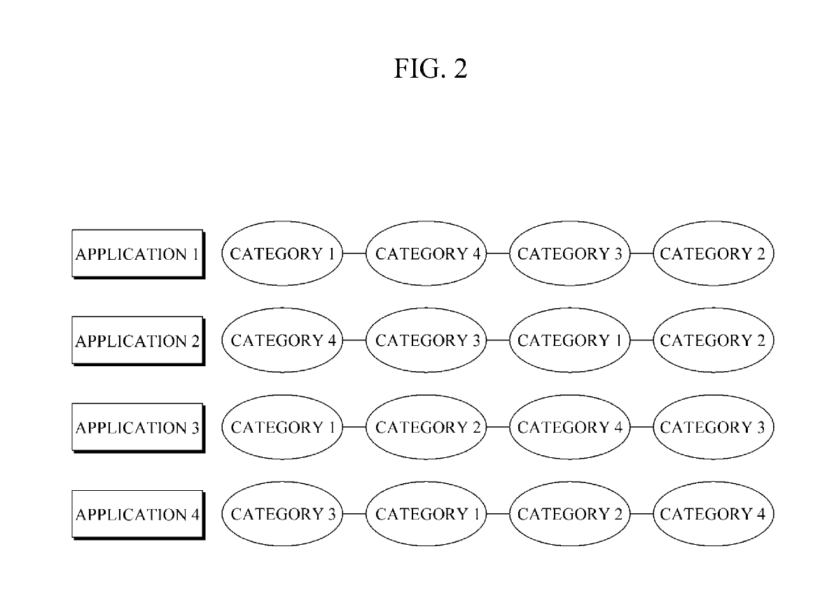

With respect to an application belonging to a second type of category, some or all applications belonging to the same category may be extracted as relevant applications. The application extraction characteristic of one or more categories may be set according to category settings, or may be set manually by the user. A more detailed description thereof will be provided later with reference to FIG. 2.

The application provision unit 132 may provide relevant applications to the user differently on the home screen and the menu screen. For example, if there are 1 to 4 icons on the home screen and 1 to 30 icons on the menu screen and applications 3 to 10 are determined relevant to application 1 or the target application, and if the user selects an icon associated with application 1 on the home screen, the application provision unit 132 may provide applications 3 and 4 as relevant applications and if the user selects an icon associated with application 1 on the menu screen, the application provision unit 132 may provide applications 3 to 10. Further, the application provision unit 132 may use a specific mark, which may be added to the application present on the home screen when the category information is stored in the database unit 120.

The application provision unit 132 may provide relevant applications of one or more categories. For example, the application provision unit 132 may provide a category list along with the relevant applications, or provide the category list first to allow the user to select a category from the category list through the user input unit 140, and then provide the relevant applications belonging to the selected category.

The application provision unit 132 may provide the user with the relevant applications in a popup window or within the displayed screen.

The categorization unit 133 may categorize an application according to its relevance determined by the determination unit. The categorization unit 133 may group the applications into the same category when the applications are determined as being relevant to each other. For example, if application properties information 1 indicates that application 2 is relevant to application 3, application properties information 2 shows that applications 1 to 4 are relevant to one another, and application properties information 3 shows that applications 1 to 3 are relevant to one another, applications 2 and 3 may be grouped together into category 1, applications 1 to 4 may be put into category 2, and application 1 to 3 may be set into category 3. The category information defined by the categorization unit 133 may be stored in the database unit 120.

The categorization unit 133 may add/delete or set/modify a category in response to a category add/deletion instruction or a category set/modification instruction inputted through the user input unit 140 or received from an external source.

The user input unit 140 may generate input data for controlling an operation of the device 100. The user input unit 140 may be implemented as a key pad, a dome switch or a touch pad, which can receive an instruction or information via a user's push or touch. In addition, the user input unit 130 may be implemented as a jog wheel or a jog scheme to rotate a key, a joystick, or a finger mouse. Further, the user input unit 140 and the display unit 110 may be integrated into a single touch screen.

When the user input unit 140 is implemented as a touch screen, the user may input a request by, for example, dragging a specific icon corresponding to an application on the touch screen in a particular direction (e.g., upward/downward or side to side), touching the icon for a certain length of time, dragging and dropping the icon to a predetermined portion of the touch screen, or shaking the device 100 while the user is touching the icon. However, aspects of the invention are not limited thereto, such that the user may input a request for the provision of relevant application using various events or input.

FIG. 2 illustrates a configuration of a database unit to store categories of an application according an exemplary embodiment of the present invention.

Referring to FIG. 2, application 1, application 2, application 3 and application 4 may be stored in the database unit 120. Further, category 1, category 2, category 3, and category 4 are associated with each of the application 1, application 2, application 3, and application 4.

The categories of an application set by the control unit 130 may be stored in the database unit 120 for one or more applications in the order of relevance.

If category 1 is determined to have the highest relevance to application 1, followed by category 4, category 3, and category 2, the database unit 120 may store the categories in this order in connection with application 1. If application 1 is classified into new category 5, which has a relevance value higher than that of category 2 but lower than that of category 3, the database 120 may update the order or hierarchy of categories associated with application 1 as category 1, category 4, category 3, category 5 and category 2, respectively. Further, the relevance of one or more categories with respect to the application may be set according to different criteria or manually set by the user.

Further, the categories may have an application extraction characteristic. The application extraction characteristic applied to one or more categories may be determined by a method for extracting applications belonging to the respective category. For example, there may be two or more types of categories corresponding to the application extraction characteristics. With respect to a target application belonging to a first type of category, relevant applications corresponding to a target application may be extracted based on the order of related categories stored in the database. With respect to a target application belonging to a second type of category, some or all applications belonging to the same category as the target application may be extracted as relevant applications. The application extraction characteristic of one or more categories may be set according to category settings, or may be set manually by the user. The application provision unit 132 may take into consideration the application extraction characteristic applied to one or more categories when providing an application relevant to the application selected by the user or executed by the device 100.

For example, application 1 may belong to both category 1 and category 4, in which the category 1 may be of a first type, and the category 4 may be of a second type. Here, to provide the relevant applications belonging to category 1, which may be a first type category, the application provision unit 132 may take into consideration the order of categories stored in the database, and only provide application 3 as the relevant application. More specifically, application 3 may be provided as the only relevant application belonging to category 1 because category 1 may be stored in the first category associated with application 1 and only application 3 has category 1 stored as its first associated category. In addition, to provide relevant applications belonging to category 4, which may be of a second type category, the application provision unit 132 may take into consideration whether one or more applications may belong to category 4. If application 2, application 3 and application 1 are all determined to have category 4 stored as their associated category, then application 2, application 3, and application 1 may be provided as relevant applications corresponding to application 4.

The database unit 120 may add a specific mark to an application that is present on the home screen when storing categories associated with the application. In response to a request for relevant applications of an application present in the menu screen, the control unit 130 may search for relevant applications present in the database unit 120 regardless of the specific mark attached to it. In addition, in response to a request for relevant applications of an application present on the home screen, the control unit 130 may only search for applications with the specific mark attached thereto.

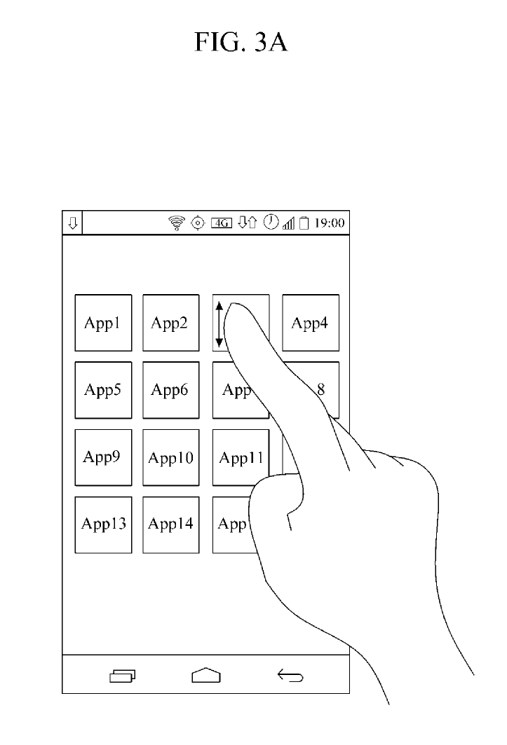

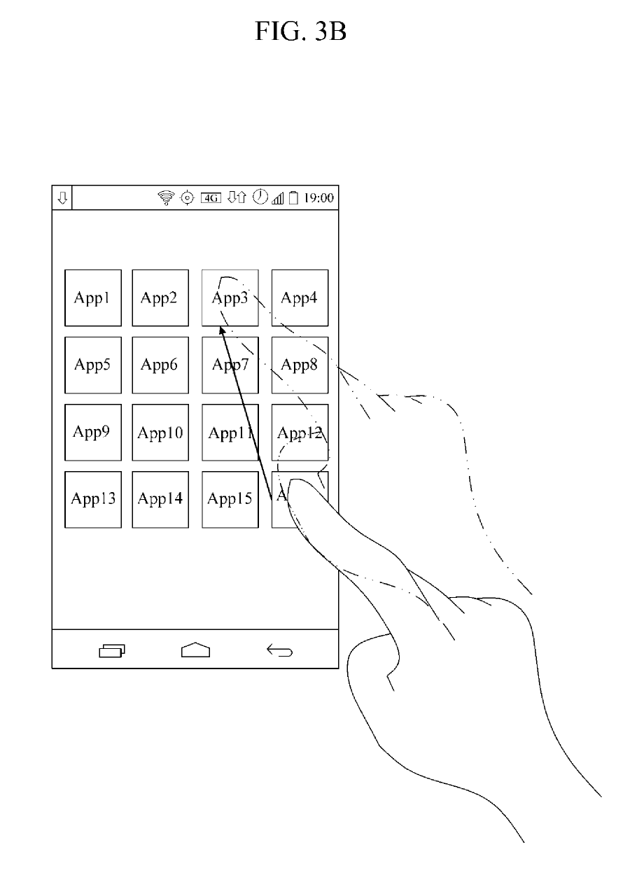

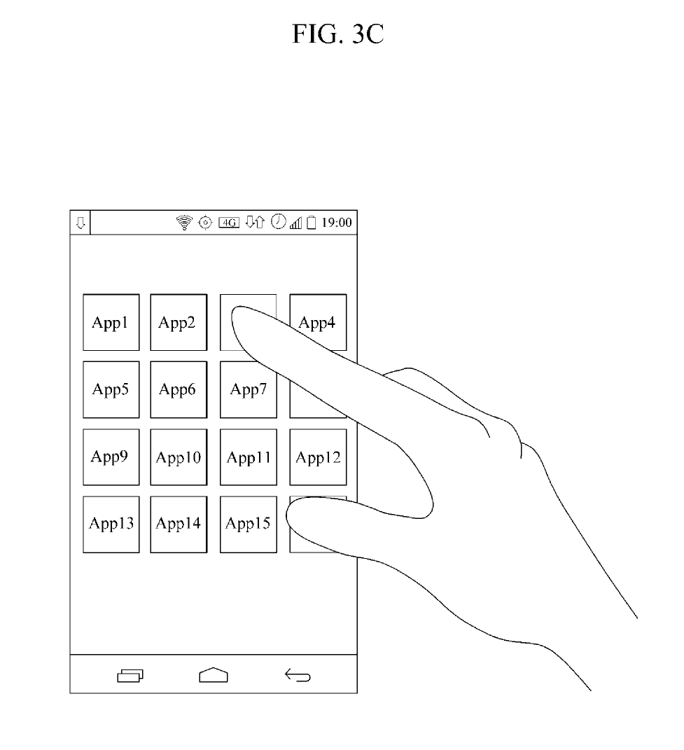

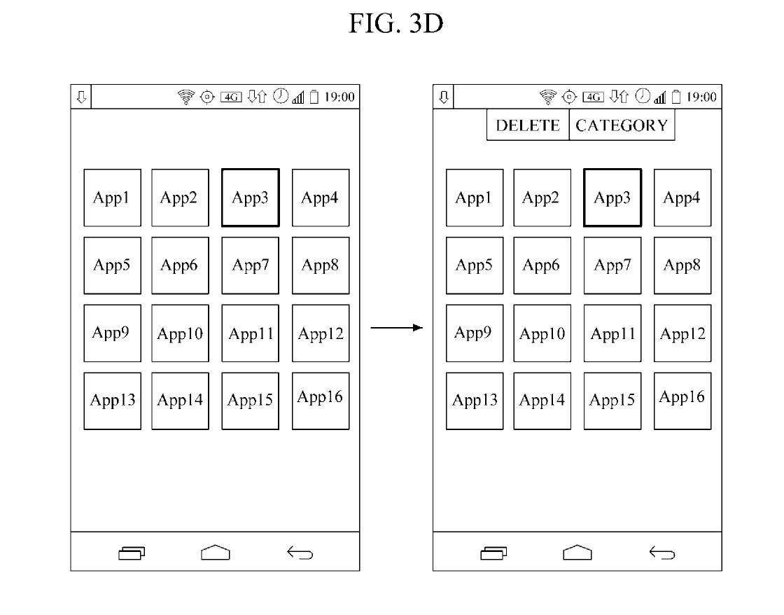

FIG. 3A, FIG. 3B, FIG. 3C and FIG. 3D illustrate a user input method for requesting relevant applications according to exemplary embodiments of the present invention. Although FIG. 3A, FIG. 3B, FIG. 3C, and FIG. 3D illustrate a touch screen is used as the user input unit 140, aspects of the invention are not limited thereto, such that other input mechanisms may be used.

Referring to FIG. 3A, in response to user's dragging of an icon on the touch screen upwards and downwards, applications relevant to an application associated with the icon may be found and displayed. However, aspects of the invention are not limited thereto, such that the user may drag the icon in various directions, such as a diagonal direction, to provide for similar results.

Referring to FIG. 3B, when the user drags the icon to overlap another icon and drops it thereon, applications which may be commonly relevant to both applications corresponding to the overlapped icons may be extracted and displayed.

Referring to FIG. 3C, when the user touches a multiple icons on the touch screen for more than a predetermined length of time, applications that are commonly relevant to the applications corresponding to the touched icons may be extracted and displayed on the touch screen.

Referring to FIG. 3D, when the user touches an icon displayed on the touch screen and drags and drops the icon into a certain portion of the touch screen, such as an upper end portion of the touch screen, a menu interface for outputting a category may appear on the touch screen. More specifically, a menu interface displaying a “delete” button or an icon and a “category” button or an icon may be provided. In FIG. 3D, if the user drags and drops an icon to overlap a particular icon, such as a trash icon, or an upper portion of the touch screen, a “delete” icon and a “category” icon may appear on the touch screen. Further, by touching the “delete” icon, the dragged and dropped icon may be deleted. Further, by touching the category icon, applications relevant to an application associated with the dragged and dropped icon may be displayed on a category basis.

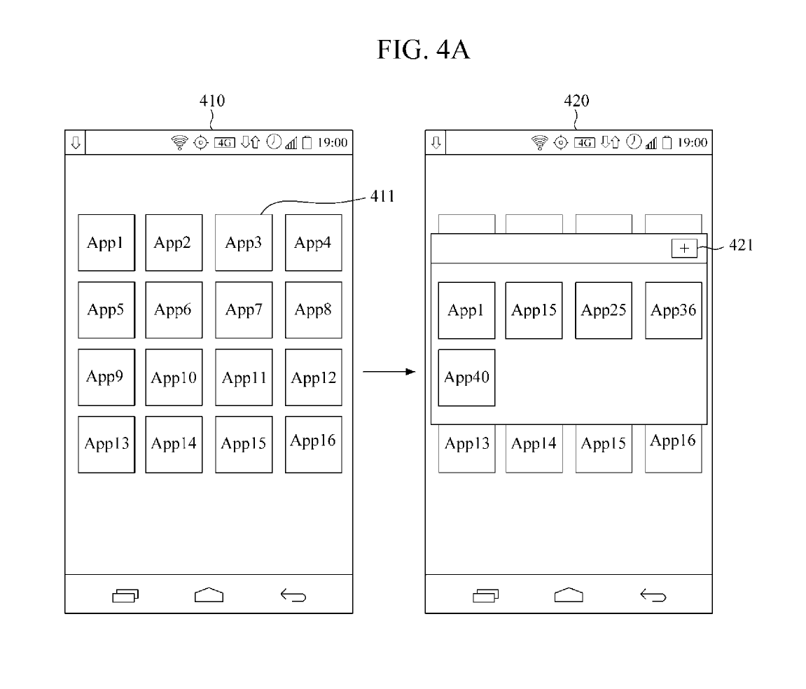

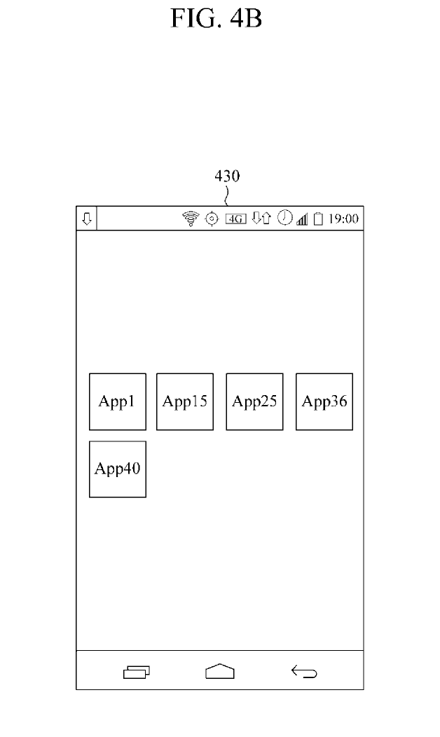

FIG. 4A and FIG. 4B illustrate diagrams of a display screen displaying icons associated with application relevant to a certain application according to an exemplary embodiment of the present invention. More specifically, FIG. 4A illustrates a display screen displaying icons of the relevant applications corresponding a target application in a popup window, and FIG. 4B illustrates a display screen displaying icons of the relevant application corresponding to a target application in a full screen according to exemplary embodiments of the present invention.

Referring to FIG. 4A and FIG. 4B, in response to a request for relevant applications corresponding to application 3 on the display screen 410 showing a number of icons corresponding to applications, the control unit 130 may search for the applications relevant to application 3 and the display unit 110 may display icons of the found applications. Further, icons of the found applications may be displayed in a popup window as shown in the right-hand screen 420 of FIG. 4A or in full screen as shown in the screen 430 of FIG. 4B. As shown in the screen 420 of FIG. 4A, an icon 421 for creating a home-screen folder may be displayed on the popup window along with icons of the relevant applications. In response to a user's selection of the icon 421, a folder based on a category may be created on the home screen.

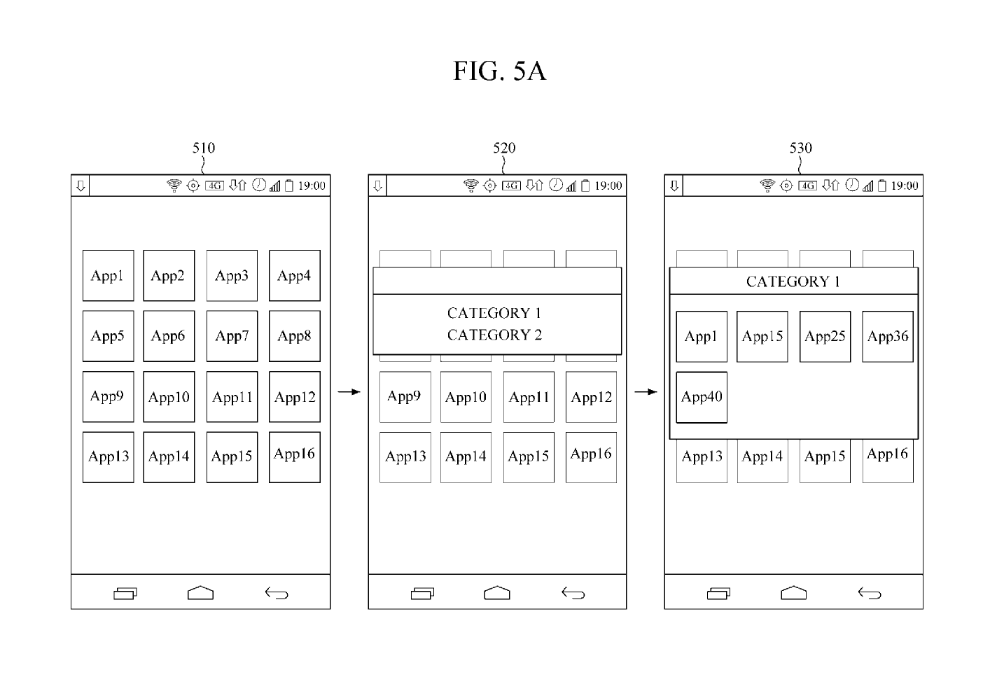

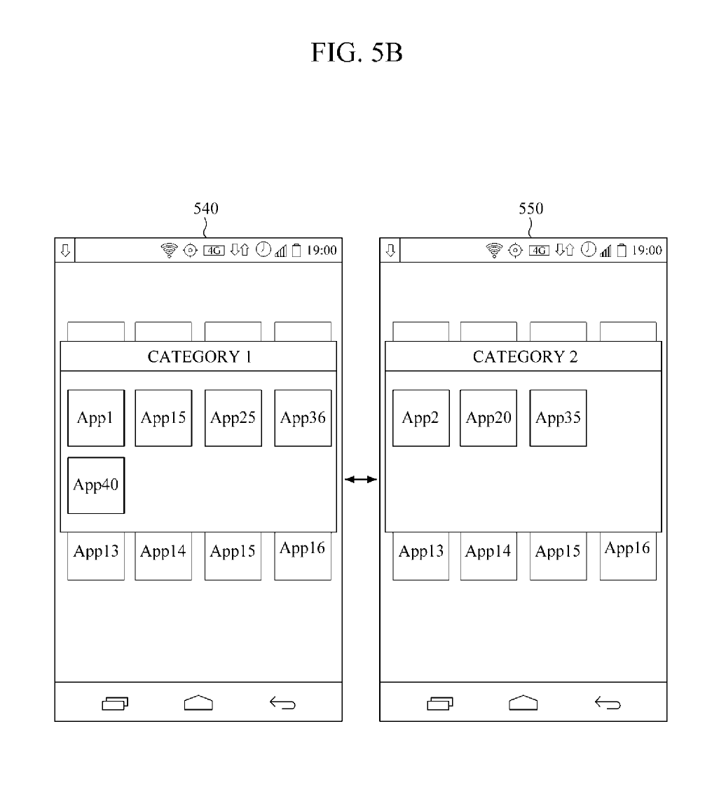

FIG. 5A and FIG. 5B illustrate diagrams of a display screen displaying applications relevant to a certain application on a category basis according to an exemplary embodiment of the present invention. More specifically, FIG. 5A illustrates a display screen displaying a list of categories corresponding to a target application while showing icons of the relevant applications, and FIG. 5B illustrates a display screen switching between two categories according to exemplary embodiments of the present invention.

Referring to FIG. 5A, in response to a request for applications relevant to application 3 in the display screen 510, which displays a number of icons corresponding to various applications, the control unit 130 may display a list of categories associated with application 3 in the display screen 520. Then, in response to a user's selection of one of the categories from the list, icons of the relevant applications corresponding to the selected category are displayed in the display screen 530. The category list may be displayed in a popup window or in full screen.

Referring to FIG. 5B, while category 1 is being displayed in a popup window, as shown in display screen 540, the popup window may be switched to display icons of relevant applications corresponding to category 2 by a particular action, as shown in display screen 550. For example, when dragging the popup window showing category 1 in a certain direction, category 2 may be displayed in a popup window. More specifically, the display screen 540 displaying category 1 and the display screen 550 displaying category 2 may be switched therebetween by an action of dragging a popup window.

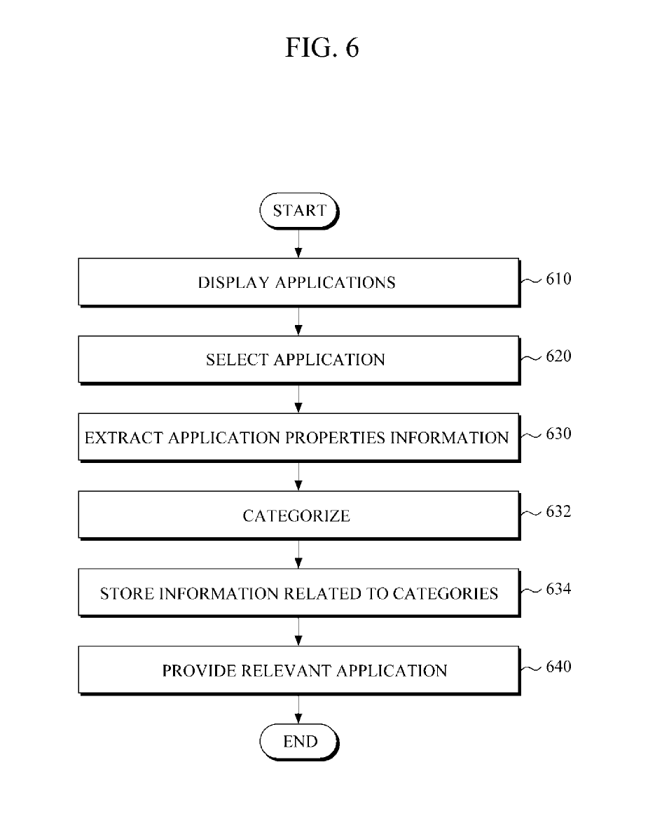

FIG. 6 illustrates a flowchart of a method for providing relevant applications according to an exemplary embodiment of the present invention.

Referring to FIG. 6, one or more applications or icons corresponding to applications are displayed in 610. In operation 620, at least one icon corresponding to an application is selected from the displayed icons corresponding to applications. For example, the at least one icon of an application may be selected by dragging the respective icon in a particular direction (e.g., upwards and downwards or side to side), touching it for more than a predetermined length of time, dragging and dropping it into a certain portion of a display screen, or touching it when a terminal's vibration is detected.

In operation 630, relevance information of one or more applications is extracted from the database unit 120, which may store application properties information including application category information. More specifically, relevance information may be based on application properties information. The application properties information may include, without limitation, at least one of market category information, name information, grouping information, such as whether the application belongs to a folder created by the user, application execution history information, package name information, and use information of hardware parts included in the terminal. Here, the hardware parts of the device may include a Bluetooth® device, a camera, a global positioning system (GPS) device, a near field communication (NFC) device, a digital multimedia player (DMB) device, and the like.

For example, the relevance of applications may be extracted based on market categories, application's name, a folder created by a user, a package name of an application, use information of hardware parts included in the terminal.

The relevant applications are provided, based on the extracted application properties information in operation 640. However, as shown in FIG. 6, operation 632 and operation 634 may be optionally be included if the respective relevant applications are to be categorized based on application properties information and to store information related to determined categories.

The relevant applications may be provided to the user differently on the home screen and the menu screen. For example, if there are 1 to 4 icons corresponding to respective applications on the home screen, and 1 to 30 icons corresponding to the respective applications in the menu screen, and applications 3 to 10 are determined to be relevant to application 1, and if the user selects an icon associated with application 1 on the home screen, the application provision unit 132 may provide applications 3 and 4 as relevant applications and if the user selects an icon associated with application 1 in the menu screen, the application provision unit 132 may provide applications 3 to 10. Here, applications corresponding to 1 to 30 may belong to the same category. However, aspects of the invention are not limited thereto, such that applications corresponding to 1 to 30 may belong to different categories.

In addition, the relevant applications may be provided on a category basis. More specifically, a category list may be displayed along with the relevant applications, or the category list may be provided first to allow the user to select a category from the category list through the user input unit 140 to display the relevant applications belonging to the selected category.

Further, the relevant applications may be provided to the user using a popup window or in full screen.

Further, in operation 632 the applications are categorized according to the extracted application properties information. For example, the applications determined as being relevant to each other based on the extracted application properties information may be classified into the same category. An application may belong to one or more categories. Further, although not illustrated, the determined categories corresponding to an application may have a hierarchical order according to relevance of the respective category.

In operation 634, information about the categories including the applications may be stored in the database unit 120. For example, the categories may be stored in the database unit 120 according to the order of relevance with respect to each application. In addition, an application present on the home screen may have a specific mark added when category including the application is stored.

According to aspects of the invention, applications installed in a device may be analyzed and categorized, the resulting application category information may be stored, and applications relevant to a certain application selected by a user may be provided to the user based on application properties information containing the application category information. Therefore, it may be possible that the user finds the target application from the relevant applications even when choosing a similar application.

Also, it may be possible to arrange applications on a category basis without manually organizing the applications.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A method for identifying a relevant application corresponding to a target application, the method comprising:
displaying a plurality of icons corresponding to applications;
selecting an icon corresponding to a target application from among the plurality of displayed icons;
determining a category of the target application; and
identifying a relevant application based on the determined category of the target application.

2. The method of claim 1, wherein the relevant application is identified with respect to a type of an application extraction characteristic applied to the determined category.

3. The method of claim 2, wherein if the application extraction characteristic is of a first type, the relevant application is identified with respect to an order list of categories corresponding to the relevant application.

4. The method of claim 2, wherein if the application extraction characteristic is of a second type, the relevant application belongs to the same category as the target application.

5. The method of claim 1, further comprising:
displaying an icon corresponding to the relevant application.

6. The method of claim 5, wherein the icon of the relevant application is displayed in a pop up window.

7. The method of claim 5, wherein the icon of the relevant application is displayed in a full screen.

8. The method of claim 1, further comprising:
displaying a list comprising a first category and a second category corresponding to the relevant application for selection.

9. The method of claim 8, wherein an icon corresponding to a first relevant application is displayed in a window corresponding to the first category if the first category is selected.

10. The method of claim 9, wherein the window corresponding to the first category is switched to a window corresponding to the second category, which includes an icon corresponding to a second relevant application, in response to a received input.

11. The method of claim 1, wherein the relevant application is identified in response to a detected input with respect to the icon corresponding to the target application.

12. A device to identify a relevant application corresponding to a target application, the device comprising:
a display unit to display a plurality of icons corresponding to applications;
an input unit to receive a selection of an icon corresponding to a target application from among the plurality of icons; and
a control unit to determine a category of the target application, and to identify a relevant application based on the determined category of the target application.

13. The device of claim 12, wherein the icon corresponding to the target application is displayed on a home screen or a menu screen.

14. The device of claim 13, wherein if the icon corresponding to the target application is displayed on the home screen, an application having its corresponding icon displayed on the home screen is identified as the relevant application.

15. The device of claim 13, wherein if the icon corresponding to the target application is displayed on the menu screen, an application having its corresponding icon displayed on the menu screen is identified as the relevant application.

16. The device of claim 12, further comprising:
a database unit to store application properties information of an application, the application properties information comprising at least one of category information, name information, folder information, application execution history information, package name information, and use information of hardware parts included in the device.

17. The device of claim 12, wherein the control unit identifies the relevant application based on a type of an application extraction characteristic applied to the determined category.

18. The device of claim 12, wherein the control unit categorizes an application according to its relevance.

19. A method for identifying a relevant application corresponding to a target application, the method comprising:
displaying a plurality of icons corresponding to applications;
selecting an icon corresponding to a target application from among the plurality of displayed icons;
extracting application properties information corresponding to the applications from a database;
categorizing applications based on the extracted application properties information;
determining order of relevance for the categorized applications; and
providing a relevant application based on at least one of a categorization and relevance of the target application.
